(19) United States
(12) Patent Application Publication
(10) Pub. No.: US 2014/0169162 A1
(43) Pub. Date: Jun. 19, 2014

(54) METHOD AND SYSTEM TO MANAGE REAL-TIME AND NON-REAL-TIME DATA TRANSMISSION OVER A SHARED LINK WITH AN IMD

(71) Applicant: ST. JUDE MEDICAL AB, Jarfalla (SE)

(72) Inventors: Roberto Romano, Uppsala (SE); Nicklas Blidmo, Upplands Vasby (SE); Anders Becker, Solna (SE); Par Edlund, Sollentuna (SE); Leif Lychou, Spanga (SE); Hanbiao Wang, Woodland Hills, CA (US); Ing-Sheng Peter Yin, Culver City, CA (US); Thanh Tieu, Simi Valley, CA (US)

(73) Assignee: ST. JUDE MEDICAL AB, Jarfalla (SE)

(21) Appl. No.: 13/716,728

(22) Filed: Dec. 17, 2012

(51) Int. Cl. H04L 12/56

(52) U.S. Cl. CPC H04L 47/25
USPC 370/230

(57) ABSTRACT

A medical telemetry system and method are provided for communication between an implantable medical device (IMD) and an external device (ExD). The method and system collects real-time (RT) data and non-real-time (NRT) data. The method and system segment the RT data into RT packets and the NRT data into NRT packets and load the RT and NRT packets into a shared transmit buffer in the IMD in accordance with RT and NRT bandwidth allocations and/or packet size. The method and system transmit the RT and NRT packets from the IMD to the ExD in an order loaded in the transmit buffer and adjust at least one of the RT and NRT bandwidth allocations and/or packet size based on a quality of service (QoS) characteristic.

### FIELD OF THE INVENTION

Embodiments of the present invention generally relate to wireless communications with an implantable medical device (IMD), and more particularly to managing real-time and non-real-time data transmission from an IMD.

### BACKGROUND OF THE INVENTION

Telemetry is a generic term for techniques for conveying measuring data from one point to another, usually by means of radio or cable connections. Within the medical field, telemetry systems are generally used for enabling radio-frequency (RF) communication between a device worn by a patient, for example an implantable medical device such as a pacemaker and an external monitoring device. In addition to RF, inductive telemetry using magnetic fields is also a mainstream communication technology for the implanted medical device.

The communication of messages between the implantable medical device and the external monitoring device should be efficient and secure. In medical telemetry applications, when real-time physiologic data is transmitted, it is desirable that communication is not lost or delayed. However, the nature of an air interface means that some bit errors will inevitably be introduced from time to time. It is desirable to limit the effects of lost individual bits or lost data packets. When a data packet is lost in transmission or received in a corrupt state, the associated data packet may be retransmitted once or more. If the communication link between the implantable medical device and the external monitoring device is deficient, then an excessive number of retransmissions is required, which increases the power consumption of the implantable medical device. Besides the risk of losing real-time physiological data, the service time of the battery of the IMD is also shortened.

Another way of rendering the communication efficient is to bundle data to be transmitted efficiently. Communication packets are often made smaller to speed them through the network or because of specified packet size restrictions in a given path. A segmentation and reassembly process is a process to accomplish this, that is, to break a communication packet into smaller units before transmission and reassembling them into the proper order at the receiving end of the communication.

An IMD often sends data to an external instrument (ExD) for a physician to review. The data often include both the real time data and non-real-time data. For example, during a typical pacemaker/ICD follow-up session, the physician may turn on the ExD live rhythm display (LRD) to provide a side-by-side comparison between the real-time internal electrocardiogram (IEGM) captured by (and streamed from) the IMD and the surface electrocardiogram (ECG) captured by an ECG machine or the ExD. The IEGM and the ECG are synchronized in order to provide accurate timing information to the physician. To maintain synchrony, the IEGM data from the IMD should arrive at the ExD with a small limited jitter and delay (e.g. within a few milliseconds from the time of collection).

Simultaneously, and in parallel to the real-time IEGM streaming, the physician may also retrieve the stored electrocardiogram (SEGM) or diagnostic data from IMD for review. In contradiction to the real-time IEGM data, a slight delay may occur from when the SEGM or diagnostic data are sent by the IMD and then received by the ExD, but a slight delay would have negligible impact in connection with informing the physician.

The IMD-ExD communication often relies on a one-hop wireless link that could be either inductive or RF. If the underlying link protocol reserves certain bandwidth for the real time data (e.g. through the time-division multiplexing and the like) at a fixed ratio, then the protocol may have a straightforward manner to limit the maximum delay and jitter as long as the underlying link condition is supported.

However, the real time data rate and the non-real-time data rate do not always have a fixed ratio. Instead, at certain times more non-real-time data may be generated, and at other times more real-time data may be generated. Hence, a fixed bandwidth reservation scheme often cannot fully utilize the link bandwidth capacity, and thus wastes precious IMD energy.

Heretofore, an alternative protocol has been proposed, namely a shared best-effort (SBE) link that interleaves real-time data and non-real-time data on a first-come-first-serve basis. A SBE link generally has higher bandwidth utilization. However, an SBE link may exhibit more real time data streaming delay and jitter. The potential exists that the real time data streaming delay and jitter may grow out of control.

Different mechanisms have been proposed to achieve quality of service (QoS) in the large scale multi-hop network system for applications such as voice over IP. These proposals mainly control the worst-case total delay and jitters across multiple hops. The applications normally allow the end receiver to counter some significant total jitters by storing incoming packets briefly in a “de-jitter” or “playout” buffer. The QoS control is mainly located at the end receiver and the relay points in the middle. The sender plays a less active role in the QoS control. The receiver does not directly affect the sender behavior through feedback.

However, conventional QoS processes have been unable to meet the unique challenge of IMD to ExD wireless communication. For example, the IEGM signals from the IMD need to be synchronized in time with the ECG signals from surface electrodes. The ExD at the receiving end has very little room to use a “playout buffer” to smooth out any significant jitter in the IEGM signals. Hence, the jitter in the IEGM signals received over the shared best-effort link should be controlled within a small tolerance range (e.g., a few milliseconds). The conventional QoS processes have experienced difficulty in meeting the strict IMD communication requirements.

A need remains for improved methods and systems that afford a desired quality of service solution over a shared best-effort link and that control the real-time data delay and jitter without wasting bandwidth.

### SUMMARY

In accordance with one embodiment, a method is provided for a medical telemetry system for communication between an implantable medical device (IMD) and an external device (ExD). The method comprises collecting real-time (RT) data and non-real-time (NRT) data; segmenting the RT data into RT packets and the NRT data into NRT packets; loading the RT and NRT packets into a shared transmit buffer in the IMD in accordance with RT and NRT bandwidth allocations; transmitting the RT and NRT packets from the IMD to the ExD in an order loaded in the transmit buffer; and adjusting at least one of the bandwidth allocation and packet size based on a quality of service (QoS) characteristic.

The QoS characteristic may represent at least one i) of a link quality between the IMD and the ExD, ii) a data rate for RT packets, and iii) a usage level for the transmit buffer. The adjusting operation may include temporarily pausing the loading of NRT packets to the transmit buffer while the link quality drops below a predetermined link threshold or for a hysteresis time period. The adjusting operation may also include temporarily pausing the loading of NRT packets to the transmit buffer while the data rate associated with transmission of RT packets drops below a predetermined RT rate threshold or for a hysteresis time period. The adjusting operation may include temporarily pausing the loading of NRT packets to the transmit buffer while the transmit buffer fills above a predetermined buffer-overflow threshold or for a hysteresis time period.

In accordance with one embodiment, the link quality corresponds to one of a signal-to-noise ratio, a bit error rate (e.g. the # bits with errors/# of bits received), latency, jitter and a number of packet transmit retries out of a predetermined number of packets. The method further comprises transmitting, from the ExD, an instruction directing the IMD to dynamically adjust at least one of the bandwidth allocation and packet size. The method further comprises automatically determining, at the IMD, how to dynamically adjust the at least one of the bandwidth allocation and packet size.

The method reduces the bandwidth allocation for NRT packets by reducing an NRT rate at which the NRT packets are loaded to the transmit buffer relative to an RT rate at which the RT packets are loaded, when at least one i) of a link quality between the IMD and the ExD, ii) a data rate for RT packets, and iii) a usage level for the transmit buffer reach a corresponding predetermined threshold; and increasing the NRT rate relative to the RT rate when a hysteresis timer times out. The RT data includes IEGM data collected real-time by the IMD.

In accordance with one embodiment, the method further comprises co-displaying the RT data and ECG signals on a display for the ExD. The transmitting operation utilizes a shared best efforts link to convey RT and NRT data to the ExD.

In accordance with one embodiment, an implantable medical device (IMD) is provided, comprised of: a transmitter/receiver for communication with an external device (ExD), inputs configured to collect real-time (RT) data, a controller configured to obtain non-real-time (NRT) data, the controller configured to segment the RT data into RT packets and the NRT data into NRT packets and load the RT and NRT packets into a shared transmit buffer in accordance with bandwidth allocation and packet size, and a transmitter configured to transmit the RT and NRT packets from the IMD to the ExD in an order loaded in the transmit buffer, wherein the controller is configured to adjust at least one of the bandwidth allocation and packet size based on a quality of service (QoS) characteristic.

The QoS characteristic may represent at least one of i) a link quality between the IMD and the ExD, ii) a data rate for RT packets, and iii) a usage level for the transmit buffer. The controller temporarily may pause the loading of NRT packets to the transmit buffer while the link quality drops below a predetermined link threshold or for a hysteresis time period. The controller may temporarily pause the loading of NRT packets to the transmit buffer while the data rate associated with transmission of RT packets drops below a predetermined RT rate threshold or for a hysteresis time period. The controller may temporarily pause the loading of NRT packets to the transmit buffer while the transmit buffer fills above a predetermined buffer-overflow threshold or for a hysteresis time period. The controller may dynamically adjust the bandwidth allocation or packet size based on link quality which corresponds to one of a signal-to-noise ratio, a bit error rate, latency, jitter and a number of packet transmit retries out of a predetermined number of packets. The bit error rates can be estimated as (# bits with error)/(# bits received).

### BRIEF DESCRIPTION OF THE DRAWINGS

FIG. 1A illustrates an IMD and external device coupled to a heart in a patient and implemented in accordance with one embodiment.

FIG. 1B illustrates a screen shot of an example of the type of real-time and non-real-time data that may be displayed on the display of the external device.

FIG. 2A illustrates a data flow diagram of a conventional approach to data management in a medical telemetry system when communications link quality is good.

FIG. 2B illustrates a data flow diagram of a conventional approach to data management in a medical telemetry system when a communications link quality is poor.

FIG. 3 illustrates a data flow diagram for RT and NRT data implemented in accordance with an embodiment of the present invention.

FIG. 4 illustrates a bandwidth and packet size management process that affords the data flow of FIG. 3 as implemented in accordance with an embodiment of the present invention.

FIG. 5 illustrates a state table associated with QoS data management as implemented in accordance with an embodiment.

FIG. 6 illustrates a state table associated with incremental changes in QoS data management as implemented in accordance with an embodiment.

FIG. 7 shows an exemplary IMD that is implanted into the patient as part of an implantable cardiac system.

FIG. 8 illustrates a functional block diagram of the external device that is operated in accordance with the processes described herein and to interface with implantable medical devices as described herein.

FIG. 9 illustrates a distributed processing system in accordance with one embodiment.

### DETAILED DESCRIPTION

In the following detailed description, reference is made to the accompanying drawings which form a part hereof, and in which are shown by way of illustration specific embodiments in which the present invention may be practiced. These embodiments, which are also referred to herein as “examples,” are described in sufficient detail to enable those skilled in the art to practice the invention. It is to be understood that the embodiments may be combined or that other embodiments may be utilized, and that structural, logical, and electrical variations may be made without departing from the scope of the present invention. For example, embodiments may be used with a pacemaker, a cardioverter, a defibrillator, and the like. The following detailed description is, therefore, not to be taken in a limiting sense, and the scope of the present invention is defined by the appended claims and their equivalents. In this document, the terms “a” or “an” are used, as is common in patent documents, to include one or more than one. In this document, the term “or” is used to refer to a nonexclusive or, unless otherwise indicated.

The following abbreviations shall be used herein:

### IMD Implantable Medical Device

### ICD Implantable Cardioverter-Defibrillator

### ExD External Instrument or Device

### ECG Surface Electrocardiogram

IEGM Internal Electrocardiogram captured by IMD

### SEGM Stored Internal Electrocardiogram IMD

LRD Live Rhythm Display, of ECG and IEGM on programmer.

### RF Radio Frequency

### RT Real-Time

### NRT Non-Real-Time

### FIFO First In First Out

### QoS Quality of Service

### SBE Shared Best Efforts

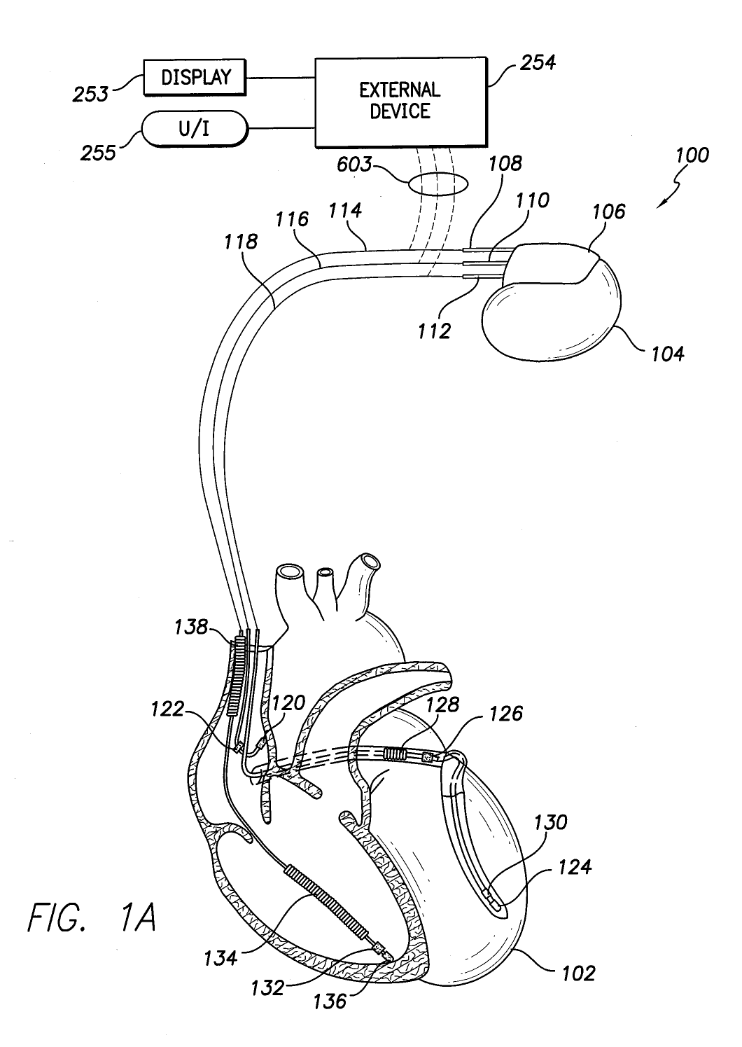

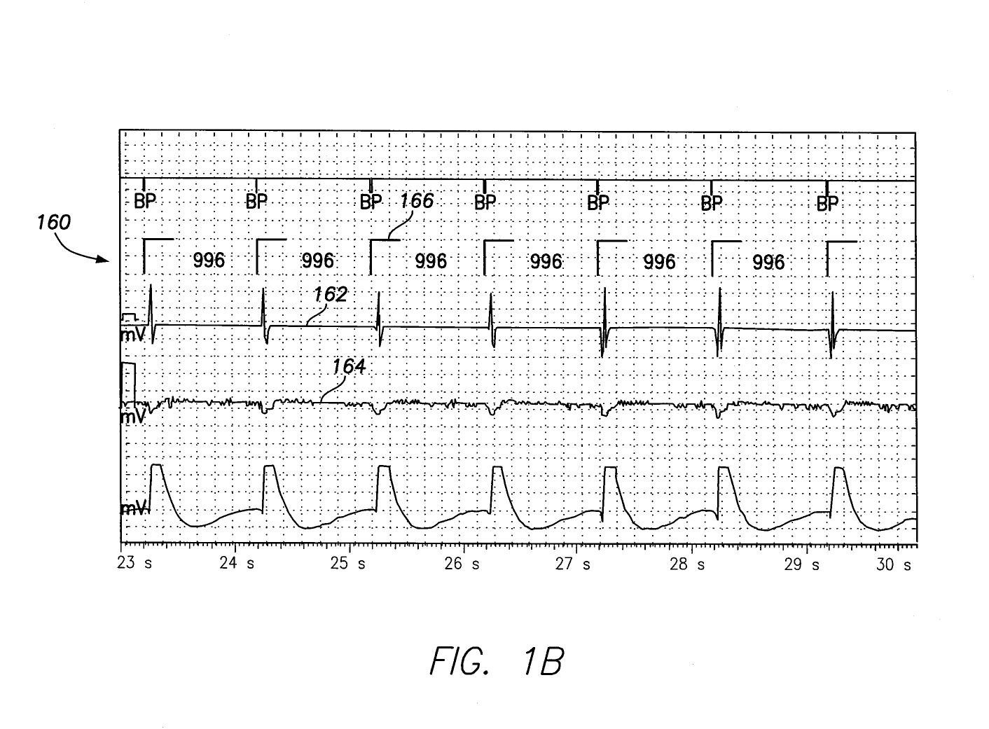

FIG. 1A illustrates an IMD 100 and external device 254 coupled to a heart 102 in a patient and implemented in accordance with one embodiment. The ExD 254 may represent any of several different types of external devices configured to communicate with an IMD, such as an external programmer, a home based monitor in a PCN, a cellular phone, a personal digital assistant, a desktop or laptop computer, a notebook computer, a smart phone (e.g., an iPhone® by Apple), an electronic reader or tablet device (e.g., a Kindle device by Amazon, a Nook device, an iPAD® device by Apple). The external device includes a display 253 and a user interface 255. The user interface 255 affords a means whereby a physician, the patient or another user may enter commands and control various operations. The display displays various information, such as past history of the patient's physiologic behavior, past operational status of the IMD, current operational state of the IMD (e.g., battery status, lead integrity, etc.), current state of the patient's physiologic behavior (e.g., real-time externally and internally collected data, such as ECG signals, IEGM signals, pressure readings, heart sounds, impedance measurements, etc.) and the like.

By way of example, the IMD 100 may represent any of several different types of implantable devices, such as a pacemaker, cardioverter, defibrillator, neurostimulator, CRT device, implantable monitor and the like. The IMD 100 may be a dual-chamber stimulation device capable of treating both fast and slow arrhythmias with stimulation therapy, including cardioversion, defibrillation, and pacing stimulation, as well as capable of detecting heart failure, evaluating its severity, tracking the progression thereof, and controlling the delivery of therapy and warnings in response thereto. The IMD 100 may be controlled to sense atrial and ventricular waveforms of interest, discriminate between two or more waveforms of interest, sense heart sounds, sense impedance, sense pressure, deliver stimulus pulses or shocks, deliver a drug, and inhibit application of a stimulation pulse based on the various factors.

The IMD 100 includes a housing 104 that is joined to a header assembly 106 that holds receptacle connectors 108, 110, 112 connected to a right ventricular lead 114, a right atrial lead 116, and a coronary sinus lead 118, respectively. The leads 114, 116, and 118 measure cardiac signals of the heart 102. The right atrial lead 116 includes an atrial tip electrode 120 and an atrial ring electrode 122. The coronary sinus lead 118 includes a left ventricular tip electrode 124, a left atrial ring electrode 126, and a left atrial coil electrode 128. The coronary sinus lead 118 also is connected with an LV ring electrode 130 disposed between the LV tip electrode 124 and the left atrial ring electrode 126. The right ventricular lead 114 has an RV tip electrode 136, an RV ring electrode 132, an RV coil electrode 134, and an SVC coil electrode 138. The leads 114, 116, and 118 detect IEGM signals that form an electrical activity indicator of myocardial function over multiple cardiac cycles. Optionally, the IMD 100 may be joined to neurostimulation/sensing leads instead of, or in addition to, the leads of FIG. 1A.

FIG. 1B illustrates a screen shot of an example of the type of real-time and non-real-time data that may be displayed on the display 253 of the external device 254. In FIG. 1B, a physiology window 160 (LRD) presents an IEGM signal 162 and an ECG signal 164 along a common timeline such that the IEGM and ECG signals 162, 164 associated with a common cardiac event are aligned temporally with one another. The IEGM signals 162 represent at least part of the RT data transmitted from the IMD 100, while the ECG signals 164 represent at least part of the external data collected by or input to the ExD 254. The window 160 also illustrates markers 166 that may be transmitted from the IMD 100 as part of the RT data.

The screen shot also illustrates patient and device related information that is transmitted from the IMD 100 as non-real-time data, such as the current device mode (e.g., VVI, DDD, etc.), the last time the mode changed, alert information. Examples of other NRT data include an occurrence of ischemia episodes, a count and date of ischemia episodes, a count of elevated ST segments, histograms counting AMI ischemia and other episodes, segment shifts, etc., QRS segments during events of interest, the foregoing and other information associated with heart rate zones, and the like.

Embodiments herein present methods and systems for improving QoS, quality of signal, over a shared best-effort link between the IMD 100 and the ExD 254. The methods and systems prioritize real-time data over non-real-time data in connection with dynamic bandwidth allocation. Given that the wireless link quality may change rapidly, the total bandwidth may fluctuate greatly. The methods and systems described herein maintain a desired QoS by adapting to rapid link quality changes to avoid undue delay in transmission of RT data. For example, RT and NRT data flow may be managed by first allocating all or a majority of bandwidth available to RT data. The NRT data may be allocated bandwidth only after the real-time data is served (e.g., transmitted) and synchrony with external data is maintained. The methods and systems described herein not only maintain the real-time data performance, but also fully utilize the available bandwidth.

As used herein, the term “delay”, shall generally refer to a time difference between arrival times for internally collected physiologic signals and externally collected physiologic signals. The arrival times are measured with respect to a common device that receives both of the internal physiologic signals and external physiologic signals. For example, when the internal and external physiologic signals represent IEGM and ECG signals, the delay refers to the time difference between a point in time at which an RT packet arrives at a receiver (e.g., the receiver in an ExD) and a point in time at which ECG or other externally acquired physiologic data arrive at an input (e.g., an input for an ExD).

As used herein, the term “jitter” shall refer to a variation in packet transit timing caused by queuing, contention and serialization effects on the wireless transmission path through the network. In general, higher levels of jitter are more likely to occur on either slow or heavily congested links. Various approaches have been used for measuring jitter. For example, packet to packet delay variation may be used as a basis for jitter measurement. If the delay of two successive packets is t1 and t2 then the packet to packet delay variation is abs (t2−t1). The mean packet to packet delay variation is therefore: MPPDV=mean (abs(ti−ti−1)). The value calculated using this approach corresponds to the peak to peak jitter level only if the packets arrive alternately early and late. For example, if packets arrived according to the following sequence early, early, late, late then the reported value would be half that for the sequence early, late, early, late. A running estimate of this mean may be calculated using the following approach: estimated mean Ji=(15·Ji−1+abs(ti−ti−1))/16.

Another measure of jitter represents mean absolute packet delay variation. If the nominal arrival time (denoted below ai) for a packet is known or can be determined then the absolute delay variation is abs (ti−ai). The mean absolute packet delay variation is therefore: MAPDV=mean (abs(ti−ai)). This value can be misleading if a delay change occurs (e.g. route change), as a constant offset would be included. As even fixed jitter buffers can adapt to delay shifts this means that the reported jitter value would not necessarily be a good indicator of ideal jitter buffer size or discard rate.

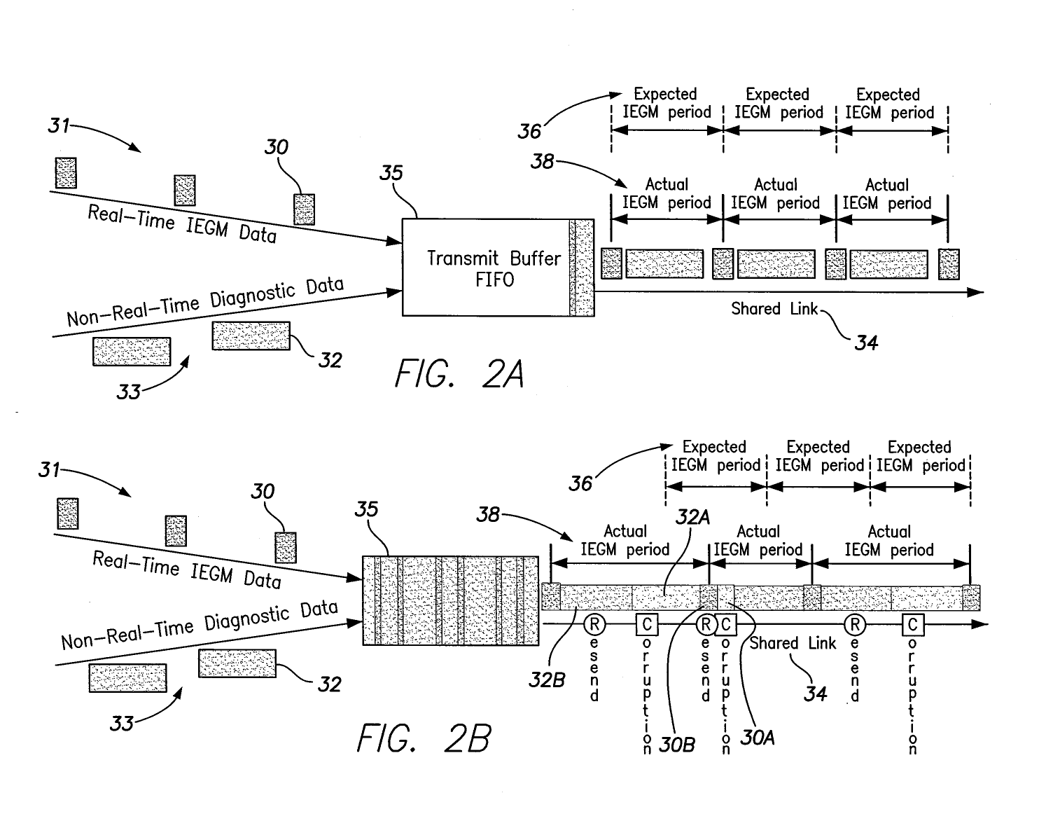

FIG. 2A illustrates a data flow diagram of a conventional approach to data management in a medical telemetry system when the communications link quality is good. In the example of FIG. 2A, a transmit buffer 35 from a pacemaker/ICD is loaded with RT and NRT packets 30, 32. In the conventional approach, the RT packets (e.g., IEGM data) and the NRT packets 32 (e.g., file transfer packets such as memory streaming) from streams 31 to 33 are simply queued into the shared transmit buffer 35 in the first-come-first-serve order. Then the RT and NRT packets 30, 32 are de-queued and transmitted over a shared wireless link 34 one by one in the order loaded. When the link quality is good enough to support both types of data traffic at whatever rate loaded, the real-time packets 30 arrive at the ExD with a low amount of jitter and delay.

FIG. 2B illustrates a data flow diagram of the conventional approach to data management in the medical telemetry system of FIG. 2A, but when a communications link quality is poor. In the example of FIG. 2B, the transmit buffer 35 is loaded with RT and NRT packets 30, 32 in a first-come-first-serve manner from streams 31 and 33. The RT and NRT packets 30, 32 are de-queued and transmitted over the shared wireless link 34 one by one. However, when the link quality degrades and one or more RT and/or NRT packets 30, 32 are corrupted over the air, the IMD retransmits the corrupt/lost RT and/or NRT packets.

In FIGS. 2A and 2B, when an RT packet 30 or NRT packet 32 is received at the ExD in a corrupt state (as indicated at 30A and 32A), the IMD 100 resends all or a portion of the same RT packet and/or NRT packet (as indicated at 30B and 32B). The SBE link 34 is conceptually segmented into an expected RT data (e.g., IEGM) period 36 and an actual RT data (e.g., IEGM) period 38. The expected RT data period 36 represents a data rate limit at which RT data packets should be transmitted to maintain steady flow of RT data from the point when sensed until displayed. As shown in FIG. 2B, when corrupt RT and NRT packets are transmitted too often, the actual RT period 38 extends far beyond the length of the expected RT period 36.

Retransmission of corrupt/lost RT and/or NRT packets (or portions of packets) adds delay and/or adds jitter to the later RT/NRT packets. Furthermore, retransmission of corrupt/lost RT/NRT packets (or portions of packets) causes the effective transmission data rate to drop. When the effective data transmission rate drops below a rate at which data is incoming to the transmit buffer, then the shared transmit buffer will eventually overflow and cause permanent data loss. When data overflow or data loss occur, this will lead to a choppy and fragmented real-time IEGM display.

When a large enough number of real-time packets carrying IEGM data are lost or delayed, the IEGM signals received by the ExD will fall out of synchronization with the ECG signals received by the ExD. The ExD will discard the out-of-sync IEGM signals and omit the IEGM signals from the live rhythm display on the ExD to avoid misleading the physician. Hence, in the conventional approach, the non-real-time data competes for the bandwidth, and could severely disrupt the real-time IEGM data to the point of making the real-time data useless.

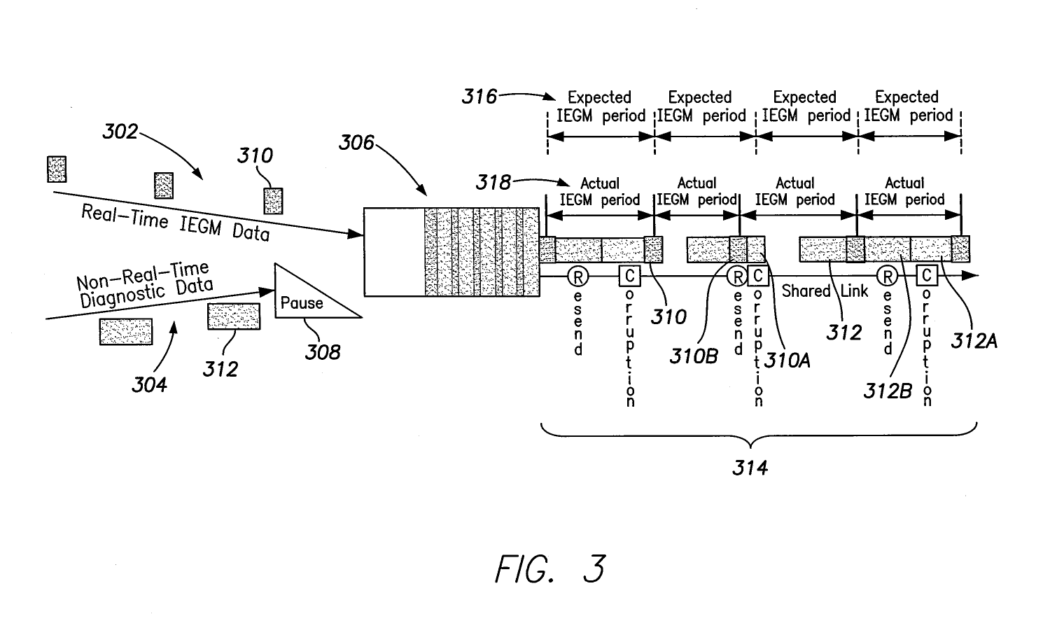

FIG. 3 illustrates a data flow diagram for RT and NRT data in accordance with an embodiment of the present invention. In FIG. 3, an RT data stream 302 and an NRT data stream 304 are supplied and loaded into the transmit buffer 306 as RT and NRT packets 310 and 312, respectively, in accordance with current RT and NRT bandwidth allocations.

The RT packets 310 and NRT packets 312 are transmitted over the SBE link 314. When an RT packet 310 or NRT packet 312 is received at the ExD in a corrupt state (as indicated at 310A and 312A), the IMD 100 resends all or a portion of the same RT packet and/or NRT packet (as indicated at 310B and 312B). The SBE link 314 is conceptually segmented into an expected RT data (e.g., IEGM) period 316 and an actual RT data (e.g., IEGM) period 318. The expected RT data period 316 represents a predetermined data rate limit at which RT data packets should be transmitted to maintain steady flow of RT data from the point when sensed until displayed. For example, the predetermined data rate limit may correspond to, or be based on, the rate at which RT data is collected from the patient. The RT and NRT bandwidth allocations are managed to maintain the actual RT data period 318 within the expected RT data period 316.

As explained herein, the NRT data stream 304 may be paused at 308 to enable a larger number of RT packets 310 to be loaded into the transmit buffer 306. By stopping and starting the NRT data stream 304 at 308, the methods and systems described herein maintain the actual estimated RT data periods within the predetermined data rate limit. The data flow of FIG. 3 affords a QoS that greatly reduces the chance for IEGMs in the RT data to fall out of synchronization with ECG signals that are also collected real-time, particularly during heavy file transfer data traffic of NRT packets. As the RT packets of IEGM data approach a point where the IEGM data may fall out of synchronization, the bandwidth management process changes bandwidth allocations to allow the real-time packets carrying IEGM data to quickly recover.

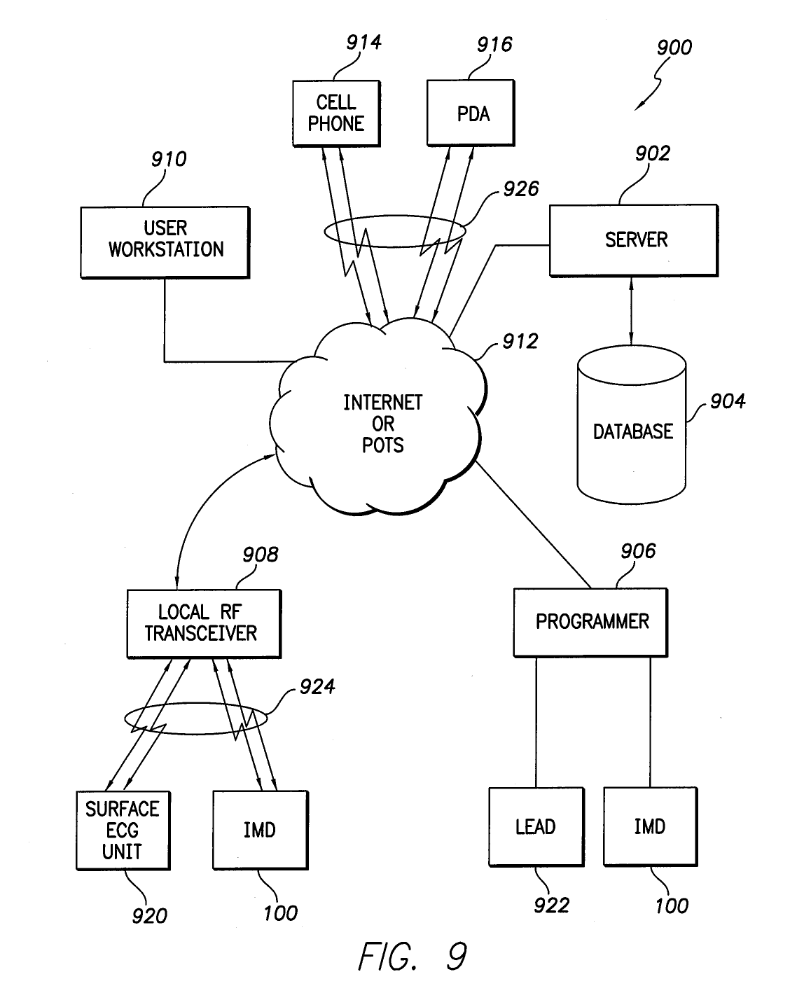

The data flow of FIG. 3 uses a highly integrated control loop across both the receiver (e.g., the ExD) and sender (e.g., the IMD). The sender (e.g. IMD) actively monitors the data transmission status and adjusts the bandwidth allocation based on feedback from the receiver (e.g. ExD). As a result, the bandwidth management process effectively addresses the bandwidth contention issue from the source. The receiver (e.g., ExD) may directly wirelessly communicate with the IMD 100 or indirectly communicate with the IMD 100 over a network 912, FIG. 9. A more active role played by the sender makes it possible to achieve a very tight control on the real-time data delay and jitter while maintaining full bandwidth utilization. The delay, corruption or other problem may arise at the SBE link, or downstream at any other point in the network 912, transceiver 908, links 926 and the like (FIG. 9).

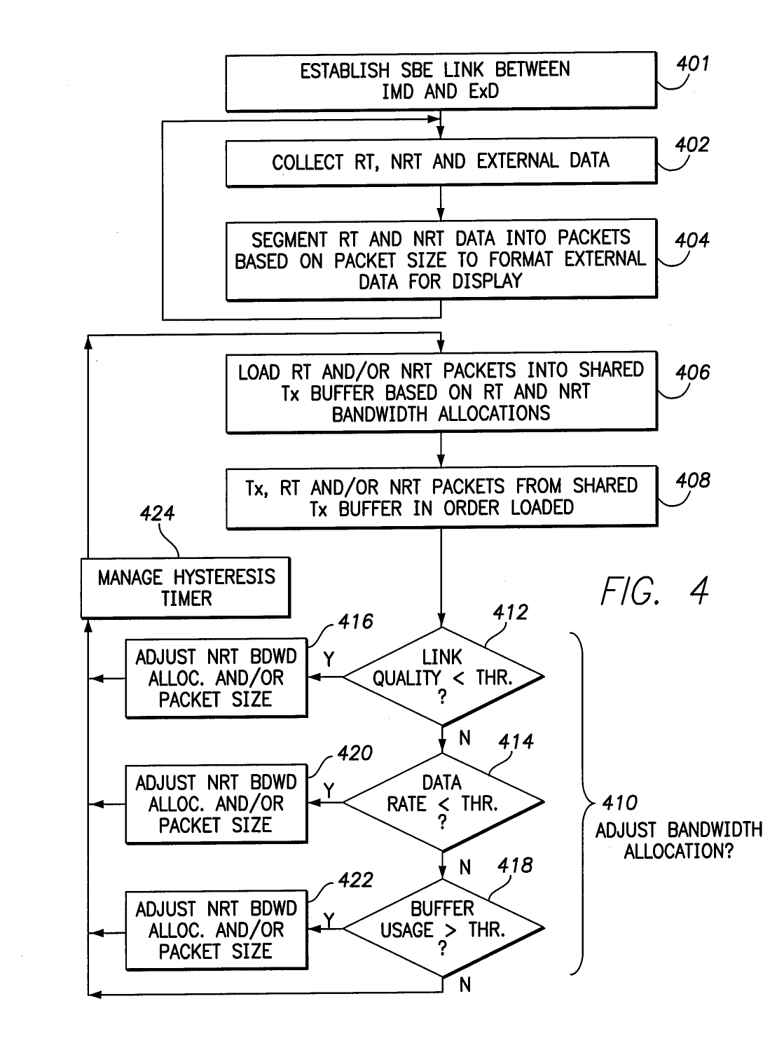

FIG. 4 illustrates a dynamic bandwidth and packet size management process that affords the data flow of FIG. 3 as implemented in accordance with an embodiment of the present invention. The method of FIG. 4 is used in a medical telemetry system for communication between an IMD and an ExD.

At 401, the method begins by establishing a shared best efforts or SBE link between the IMD and the ExD. The SBE link may be initiated by an external programmer device (e.g., under the direction of a physician), a home based patient care network (e.g., automatically or under the direction of the patient) or another external device (e.g., an external defibrillator device) and the like. The communications protocol associated with the SBE link may be any one of several known protocols associated with medical communications systems, as well as any existing wireless or cellular protocol.

As an example, the SBE link may be established in connection with an examination of a patient while at a physician's office. The physician may have the patient undergo an examination, stress test and the like, while the patient's IMD simultaneously transmits RT and NRT data to an external device such as a programmer and the like.

Optionally, the SBE link may be established in connection with self-examination of a patient while the patient is at home, the office, in an automobile and the like. The patient may undergo a self-induced examination, such as connecting a blood pressure cuff, external ECG patches as appropriate, a heart rate monitor and the like. The patient undergo a self-examination with an ExD, while the patient's IMD simultaneously transmits RT and NRT data to the external device such as a home based monitoring system, the Merlin.net Patient Care Network (PCN) and the like. The Merlin.net™ Patient Care Network (PCN), offered by St. Jude Medical Inc., allows efficient remote management, including scheduled transmissions and daily alert monitoring, of patients with an IMD including pacemakers, implantable cardioverter defibrillators and cardiac resynchronization therapy devices. The home based monitoring system may have separate inputs to receive external physiologic signals, such as external ECG signals, blood pressure readings, impedance measurements, heart sounds and the like. Optionally, the SBE link may be established between the IMD 100 and any of the ExD devices shown in FIG. 9 over the network 912.

At 402, the method collects real-time (RT) data and non-real-time (NRT) data at an IMD. The NRT data may have been collected in the past, such as over the last week, month, year. The method also collects external data at the ExD. The RT data represents patient information that is time sensitive and is reflective of a state or condition of the patient at a present point in time corresponding to the point in time at which the RT data is received at the ExD. Hereafter, examples will be discussed in the context of the RT data including IEGM data collected real-time by the IMD. However, it is understood that other types of real-time physiologic signals may be measured in addition, or instead, and transmitted to the ExD as RT data. In general, the RT data represent internal measurements of one or more physiologic signals of interest, such as IEGM signals, blood pressure readings, inter-cardiac impedance measurements, intra-cardiac impedance measurements, cardiac blood flow output, heart sounds and the like. The RT data represents a type of internally acquired patient information that can be compared to counter-part external patient information that may be measured externally. As one example, the internal and external patient information may be co-displayed on an ExD monitor to facility a physician's analysis of the patient's condition. For example, IEGM signals may be co-displayed with the ECG signals on a display for the ExD.

The external data represent real-time external measurements of one or more physiologic signals or behavior of interest, such as ECG signals, external blood pressure readings, external cardiac impedance measurements, external heart sounds, external cardiac blood flow output, and the like.

The NRT data represents patient and/or device related information that is not as time-sensitive as RT data. The NRT data may be reflective of a state or condition of the patient or device over a period of time or at a prior point in time (prior to the point in time at which the ExD receives the NRT data). For example, the NRT data may be previously recorded patient information stored in the memory in the IMD.

At 404, the IMD segments the RT data into RT packets and the NRT data into NRT packets. The RT and NRT packets may be segmented and formatted in accordance with various existing medical telemetry protocols that define a number and type of header, data and/or trailing fields in each packet. The RT and NRT packets may have a common or different size. The size of the RT and NRT packets may be set based on a current or chosen packet size. Alternatively, the size of the RT and NRT packets may vary within a data stream. As one example, the size of the RT and NRT packets may be varied in accordance with the adjustments described herein, such as based on QoS characteristics. For example, the present methods and systems may determine to increase or decrease an RT or NRT packet size. This determination may include increasing or decreasing a length of the data field within NRT packets dynamically within the NRT data stream. For example, when it is determined to decrease an NRT bandwidth allocation, it may also be determined to decrease a length of the data field within each NRT packet dynamically. The changes in data field length may be the only change or may be made in combination with a dynamic change in bandwidth allocation. Optionally, the changes in data field length may be performed in addition to changing a rate or ratio, in which RT and NRT packets are loaded into the transmit buffer.

Also at 404, the ExD formats the external data in a manner that can be stored and displayed. For example, then the external data represents ECG signals, the ECG signals are formatted for display on the monitor of the ExD. The ECG and IEGM signals may be co-displayed on the monitor of the ExD in temporal alignment such that the ECG and IGEM signals are aligned to illustrate corresponding cardiac events.

FIG. 4 illustrates multiple parallel processes. At 401-404, the IMD and ExD collect RT, NRT and external data in parallel and/or series. For example, the ExD collects data serially with respect to the IMD. The ExD collects RT and NRT (on one side) and external data (on the other side) in parallel. Simultaneously, at 406-422, the IMD ExD maintain the SBE link such that the IMD continuously transmits the RT and NRT data to the ExD for contemporaneous analysis with the external data.

At 406, the method loads the RT and NRT packets into a shared transmit buffer in the IMD based on RT and NRT present bandwidth allocations. The RT and NRT bandwidth allocations are managed, by a processor, buffer manager or transmit controller in the IMD, based on feedback from the ExD and/or based on the present state of the transmit buffer. In general, the RT and NRT packets are loaded into the shared transmit buffer in an interleaved order. The interleaved order may or may not be even. For example, when the method determines that the RT and NRT bandwidth allocations should be even, the method alternatively loads one RT packet for each NRT packet. When the method determines that the RT and NRT bandwidth allocations should be uneven (e.g., 2-to-1 or 3-to-1), the method may alternatively load two, three or more RT packets for each NRT packet. As another option, the method determine that the RT and NRT bandwidth allocations should be “only RT” or “0-NRT”, in which case the method suspends loading of NRT packets and loads RT packets successively one after the other until the bandwidth allocations are changed.

At 408, the method transmits the RT and NRT packets from the IMD to the ExD in the order that the RT and NRT packets are loaded in the transmit buffer. The transmitting operation utilizes a shared best efforts link to convey RT and NRT data to the ExD.

At 410, the method determines whether a dynamic adjustment should be made in the bandwidth allocated and/or packet size to at least one of the RT and NRT packets based on various qualities of signal characteristics. In one embodiment, the operations at 410 may be implemented by the ExD where the ExD transmits an instruction(s) to the IMD directing the IMD to adjust the bandwidth allocated and/or packet size for at least one of the RT and NRT data streams. In another embodiment, the operations at 410 may be implemented by the IMD which automatically determines how to adjust the bandwidth allocated and/or packet size to at least one of the RT and NRT data streams. The non-real-time (NRT) packet size adjustment is an effective control that does not entirely fall in the scope of the bandwidth allocation adjustment. For example, given an acceptable NRT bandwidth allocation, if the NRT packet size is too big, the real-time (RT) data can experience unacceptable levels of jitters. The methods and systems herein have identified and effectively utilized the NRT packet size control. The operations at 412-422 illustrate examples of QoS characteristics that may be tested and for which thresholds may be set. For example, the QoS characteristics may include one or more of link quality, data rate, buffer usage state and the like. Optionally, different QoS characteristics may be utilized.

At 412, the method determines whether the link quality has dropped below a predetermine link threshold. For example, the link quality may correspond to one of a bit error rate, a signal-to-noise ratio, latency, jitter, a number of packet transmit retries out of a predetermined number of packets and the like. The bit error rate is the percentage of bits received with errors, which represents a direct measure of the link quality. For example, the bit error rate may represent the number of bits with errors per number of bits received. The ExD may monitor the link quality by analyzing statistics collected both locally and from the IMD. Based on the link quality, the ExD may command the IMD to adjust the non-real-time data bandwidth allocation and/or packet size. When the link quality degrades, less non-real-time data packets are allowed to be interleaved between the two adjacent real-time data packets. When the link quality improves, more non-real-time data can be allowed. The link-quality-adaptive flow control keeps the real-time data transmission latency or jitter at a fixed level to a certain degree independent of the link quality change. To improve the flow control stability, the non-real-time data bandwidth allocation and/or packet size reduction shall be more aggressive (e.g. exponentially) than the increase (e.g. linearly).

If the link quality satisfies the threshold at 412, flow moves to 414. If the link quality drops below the threshold, flow moves to 416, where the method adjusts the RT and/or NRT bandwidth allocation and/or packet size based on a low-signal quality status. As one example, the NRT bandwidth allocation may involve temporarily pausing loading of NRT packets to the transmit buffer for a predetermined period of time or until the link quality improves to above the predetermined link threshold. Optionally, the change in RT bandwidth and/or packet size may represent an increase in the number of RT packets sent between NRT packets (RT to NRT packet ratio). For example, the ExD may instruct the IMD to increase the RT to NRT packet ratio to 3-to-1, and the like. Optionally, the change in RT packet size may represent an increase in the length of the data field or data segment in each RT packet. For example, the ExD may instruct the IMD to increase the length of the data field by X bits or bytes.

At 414, the method determines whether the RT data rate satisfies (e.g., has not dropped below) a predetermined data rate threshold. If the data rate continues to satisfy the threshold, flow moves to 418. If the data rate falls below the threshold, flow moves to 420, where the method adjusts the NRT bandwidth allocation and/or packet size based on a low-data-rate status. As one example, the NRT bandwidth allocation may involve temporarily pausing loading of NRT packets to the transmit buffer for a predetermined period of time or until the RT data rate increases to above the RT data rate threshold. Optionally, the change in RT bandwidth may represent an increase in the number of RT packets sent between NRT packets. Optionally, the change in RT packet size may represent an increase in the length of the data field or data segment in each RT packet.

At 418, the method determines whether the transmit buffer has filled above a predetermined buffer-overflow threshold (e.g., 75% full). If not, flow returns to 402. If so, flow moves to 422, where the method adjusts the NRT bandwidth allocation and/or packet size based on a buffer full status. As one example, the NRT bandwidth allocation may involve temporarily pausing loading of NRT packets to the transmit buffer for a predetermined period of time or until the buffer full status drops to below the buffer full threshold. Optionally, the change in RT bandwidth may represent an increase in the number of RT packets sent between NRT packets. Optionally, the change in RT packet size may represent an increase in the length of the data field or data segment in each RT packet.

The IMD monitors the transmit buffer usage continuously. At 418, when the transmit buffer is almost full (e.g. 75%), IMD may pause queuing of the NRT data into the shared transmit buffer at 422. The local fast feed-back loop at the IMD very effectively avoids transmit buffer overflow and RT data loss.

Optionally, when the ExD detects loss of RT data, the ExD may transmit a command instructing the IMD to pause queuing of the non-real-time data into the shared transmit buffer, regardless of whether the transmission buffer overflows or not.

As explained above, once the bandwidth allocation and/or packet size has been adjusted at 416, 420 or 422, the method may temporarily pause loading of NRT packets to the transmit buffer, change the packet size and/or change the ratio of RT to NRT packets until the QoS characteristic returns to an acceptable levExD. Alternatively, or in addition, the method may re-start loading of NRT packets to the transmit buffer when a hysteresis timer times out even if the signal quality characteristic has not returned to an acceptable levExD.

At 424, one or more hysteresis timer is managed throughout the process of 406 to 422. The hysteresis timer may be set with an initial duration and a count-down started when the non-real-time data is paused or the NRT bandwidth and/or packet size reduced below an NRT bandwidth and/or packet size lower limit. Optionally, separate hysteresis timers may be set when the NRT data is paused and when then NRT bandwidth and/or packet size is reduced. Optionally, multiple separate hysteresis timers may be set based upon an amount to which the NRT bandwidth and/or packet size is reduced.

If the real-time data recovers before the hysteresis duration times out, the ExD shall command the IMD to resume (or the IMD shall automatically resume) transmission of the non-real-time data at a predetermined NRT bandwidth and/or packet size and the hysteresis timers are reset. If the hysteresis timer(s) does time out, IMD shall resume loading and transmission of the non-real-time data to prevent it from being completely starved. Either way, the non-real-time data is resumed with the minimum bandwidth allocation and/or packet size. Then the ExD can gradually increase the non-real-time data bandwidth allocation and/or packet size if the link quality permits.

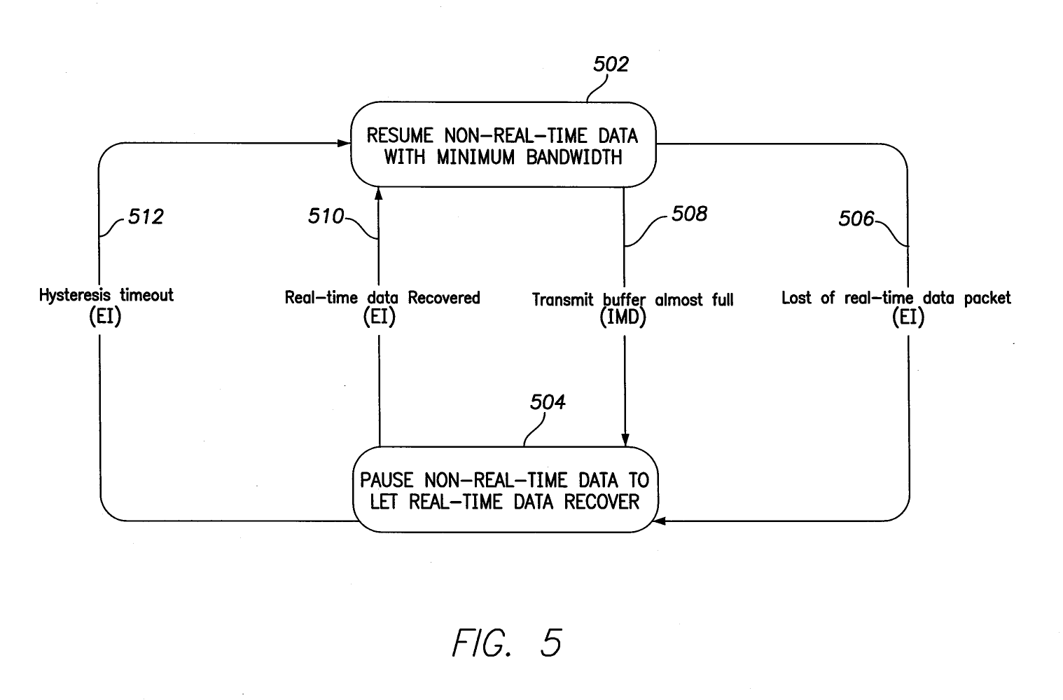

FIG. 5 illustrates a state table 500 associated with QoS data management as implemented in accordance with an embodiment. The state table 500 includes a balanced state 502 and a recovery state 504. The balanced state 502 represents an operating condition in which the IMD is transmitting RT and NRT data at rates sufficient i) to avoid an undue data back log at the input to the transmit buffer, ii) to maintain synchronized delivery (at the ExD) of the RT data with respect to external data and iii) to afford delivery of the NRT data at the ExD in a timely manner with respect to the purpose of the NRT data.

The recovery state 504 represents an operation condition in which the IMD is transmitting RT data in an unbalanced manner with respect to NRT data. For example, the IMD is transmitting RT data at an above normal rate but sufficient i) to draw down, remove or avoid an RT data back log at the input to the transmit buffer, ii) to maintain synchronized delivery (at the ExD) of the RT data with respect to external data and/or iii) to cause the NRT data to not be delivered at the ExD in a timely manner with respect to the purpose of the NRT data.

FIG. 5 further illustrates transition conditions between the states based upon different circumstances that may arise during an iterative flow through 401-424. For example, a low data rate transition (LDRT) condition 506 occurs when the ExD informs the IMD that one or a sufficient number of RT packets have been lost or were received in a corrupt condition. When the LDRT condition 506 occurs, the IMD switches state from 502 to 504. A buffer full transition (BFT) condition 508 occurs when the transmit buffer usage exceeds the buffer full threshold, thereby switching the IMD state from 502 to 504.

An RT data recovered (RT DR) condition 510 occurs when the ExD informs the IMD that one or a sufficient number of RT have been received and are not in a corrupt condition. When the RT DR condition occurs, the IMD switches state from 504 to 502. A hysteresis timeout (HT) condition 512 occurs when the hysteresis timer(s) time out, thereby indicating that the IMD has been transmitting RT data at an above normal rate (relative to NRT data) for a maximum predetermined. When the HT condition occurs, the IMD switches state from 504 to 502.

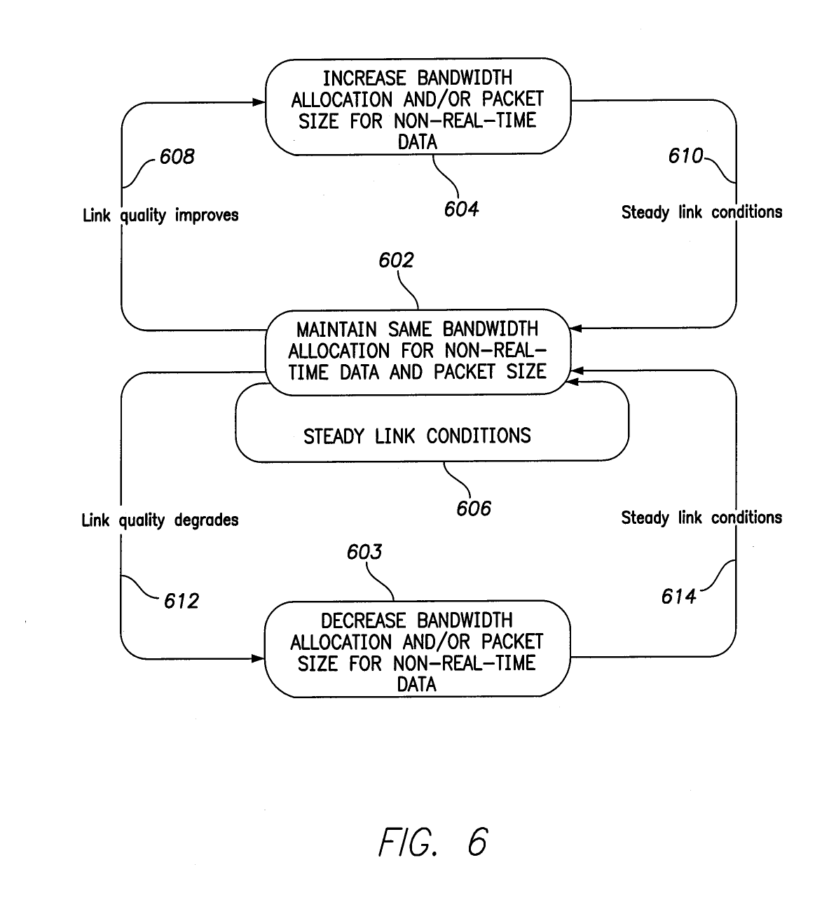

FIG. 6 illustrates a state table 257 associated with incremental changes in QoS data management as implemented in accordance with an embodiment. The state table 257 includes a balanced state 602, a decrease NRT bandwidth and/or packet size state 603 and an increase NRT bandwidth and/or packet size state 604. The balanced state 602 represents an operating condition in which the IMD is transmitting RT and NRT data at rates sufficient i) to avoid an undue data back log at the input to the transmit buffer, ii) to maintain synchronized delivery (at the ExD) of the RT data with respect to external data and iii) to afford delivery of the NRT data at the ExD in a timely manner with respect to the purpose of the NRT data. The decrease NRT bandwidth and/or packet size state 603 represents a state in which the method and system incremental decreases the bandwidth associated with NRT data, while the increase NRT bandwidth and/or packet size state 604 represents a state in which the method and system incremental increases the bandwidth and/or packet size associated with NRT data.

FIG. 6 further illustrates transition conditions between the states based upon different circumstances that may arise during 401-424 in FIG. 4. When the IMD is operating at state 602 and the link quality exhibits a steady or good condition, flow moves along transition condition 606 and nothing changes. When the IMD is operating at state 602 and the link quality changes by improving from a prior quality to a new better or higher quality, flow moves along transition condition 608 such that an amount of bandwidth allocated to NRT data and/or packet size is increased. Similarly, when the IMD is operating at state 602 and the link quality changes by degrading from a prior quality to a new lower or poor quality, flow moves along transition condition 612 such that an amount of bandwidth allocated to NRT data and/or packet size is decreased.

When the IMD is operating at state 604 and the link quality exhibits a steady or good condition, flow moves along transition condition 610 and a present bandwidth allocation and/or packet size is maintained. When the IMD is operating at state 603 and the link quality exhibits a steady or good condition, flow moves along transition condition 614 and a present bandwidth allocation and/or packet size is maintained.

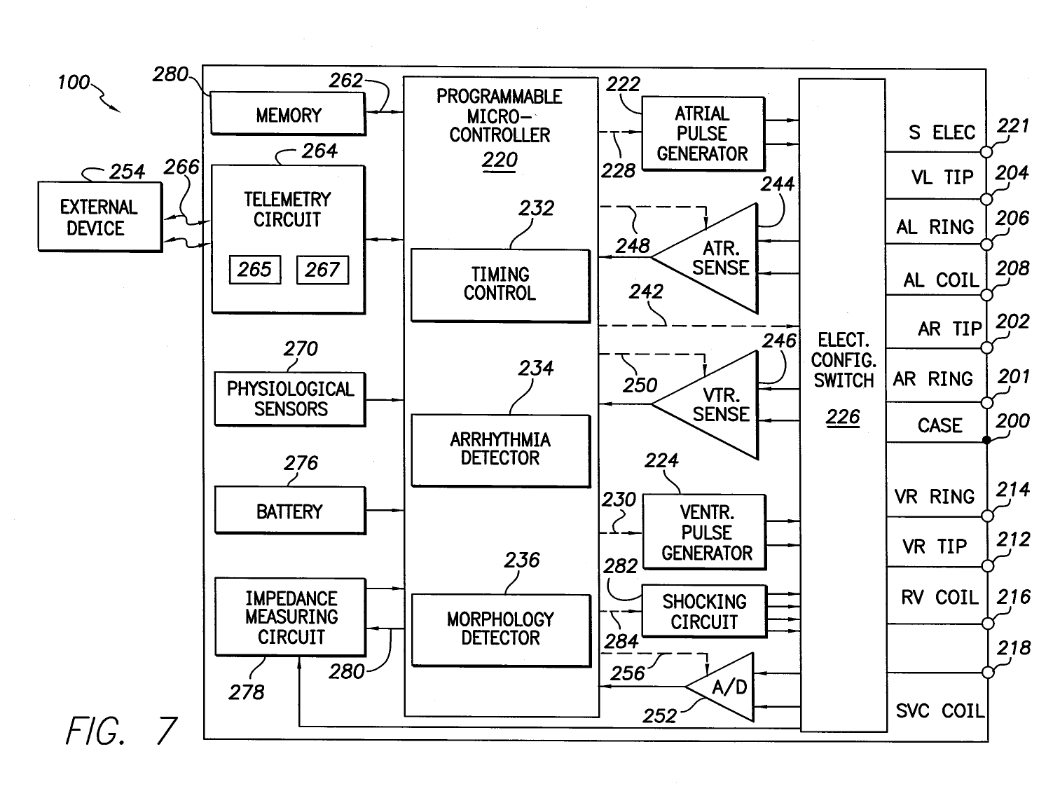

FIG. 7 shows an exemplary IMD 100 that is implanted into the patient as part of an implantable cardiac system. The IMD 100 may be implemented as a full-function biventricular pacemaker, equipped with both atrial and ventricular sensing and pacing circuitry for four chamber sensing and stimulation therapy (including both pacing and shock treatment). Optionally, the IMD 100 may provide full-function cardiac resynchronization therapy. Alternatively, the IMD 100 may be implemented with a reduced set of functions and components. For instance, the IMD may be implemented without ventricular sensing and pacing.

The IMD 100 has a housing 200 to hold the electronic/computing components. The housing 200 (which is often referred to as the “can”, “case”, “encasing”, or “case electrode”) may be programmably selected to act as the return electrode for certain stimulus modes. Housing 200 further includes a connector (not shown) with a plurality of terminals 201, 202, 204, 206, 208, 210, 212, 214, 216, 218 and 221. The terminals may be connected to electrodes that are located in various locations within and about the heart. For example, the terminals may include: a terminal 202 to be coupled to an first electrode (e.g. a tip electrode) located in a first chamber, a terminal 204 to be coupled to a second electrode (e.g., tip electrode) located in a second chamber, a terminal 206 to be coupled to an electrode (e.g. ring) located in the first chamber, a terminal 208 to be coupled to an electrode located (e.g. ring electrode) in the second chamber, and a terminal 210 to be coupled to an electrode (e.g., coil) located in the SVC. The type and location of each electrode may vary. For example, the electrodes may include various combinations of ring, tip, coil and shocking electrodes and the like.

The IMD 100 includes a programmable controller 220 that controls various operations of the IMD 100, including cardiac monitoring and stimulation therapy. Controller 220 includes a microprocessor (or equivalent control circuitry), RAM and/or ROM memory, logic and timing circuitry, state machine circuitry, and I/O circuitry.

IMD 100 further includes a first chamber pulse generator 222 that generates stimulation pulses for delivery by one or more electrodes coupled thereto. The pulse generator 222 is controlled by the controller 220 via control signal 224. The pulse generator 222 is coupled to the select electrode(s) via an electrode configuration switch 226, which includes multiple switches for connecting the desired electrodes to the appropriate I/O circuits, thereby facilitating electrode programmability. The switch 226 is controlled by a control signal 228 from the controller 220.

In the example of FIG. 7, a single pulse generator 222 is illustrated. Optionally, the IMD 202 may include multiple pulse generators, similar to pulse generator 222, where each pulse generator is coupled to one or more electrodes and controlled by the controller 220 to deliver select stimulus pulse(s) to the corresponding one or more electrodes.

Controller 220 is illustrated as including timing control circuitry 232 to control the timing of the stimulation pulses (e.g., pacing rate, atrio-ventricular (AV) delay, atrial interconduction (A-A) delay, or ventricular interconduction (V-V) delay, etc.). The timing control circuitry 232 may also be used for the timing of refractory periods, blanking intervals, noise detection windows, evoked response windows, alert intervals, marker channel timing, and so on. Controller 220 also has an arrhythmia detector 234 for detecting arrhythmia conditions and a morphology detector 236. Although not shown, the controller 220 may further include other dedicated circuitry and/or firmware/software components that assist in monitoring various conditions of the patient's heart and managing pacing therapies.

The IMD 100 includes sensing circuitry 244 and 246 selectively coupled to one or more electrodes that perform sensing operations, through the switch 226 to detect the presence of cardiac activity in the right chambers of the heart. The sensing circuitry 244, 246 may include dedicated sense amplifiers, multiplexed amplifiers, or shared amplifiers. It may further employ one or more low power, precision amplifiers with programmable gain and/or automatic gain control, bandpass filtering, and threshold detection circuit to selectively sense the cardiac signal of interest. Switch 226 determines the sensing polarity of the cardiac signal by selectively closing the appropriate switches. In this way, the clinician may program the sensing polarity independent of the stimulation polarity.

The output of the sensing circuitry 244, 246 is connected to the controller 220 which, in turn, triggers or inhibits the pulse generator 222 in response to the absence or presence of cardiac activity. The sensing circuitry 244, 246 receives control signals 248, 250 from the controller 220 for purposes of controlling the gain, threshold, polarization charge removal circuitry (not shown), and the timing of any blocking circuitry (not shown) coupled to the inputs of the sensing circuitry.

Optionally, the IMD 202 may include more or few sensing circuits where each sensing circuit is coupled to one or more electrodes and controlled by the controller 220 to sense electrical activity detected at the corresponding one or more electrodes. The sensing circuits 244, 246 may operate in a unipolar sensing configuration or in a bipolar sensing configuration.

The IMD 100 further includes an analog-to-digital (ND) data acquisition system (DAS) 252 coupled to one or more electrodes via the switch 226 to sample cardiac signals across any pair of desired electrodes. The data acquisition system 252 is configured to acquire intracardiac electrogram (IEGM) signals, convert the raw analog data into digital data, and store the digital data for later processing and/or telemetric transmission to an external device 254 (e.g., a programmer, home monitor, smart phone, e-reader, laptop computer, notebook computer, desktop computer, local transceiver, diagnostic system analyzer and the like). The data acquisition system 252 is controlled by a control signal 256 from the controller 220. Optionally, the DAS 252 may acquire other physiologic signals instead of, or in addition to, IEGM signals. For example, the DAS 252 may acquire other physiologic signals, such as blood pressure readings, impedance measurements, cardiac output readings, acoustic measurements, heart sounds and the like.

The controller 220 is coupled to a memory 260 by a suitable data/address bus 262. The programmable operating parameters used by the controller 220 are stored in memory 260 and used to customize the operation of the IMD 100 to suit the needs of a particular patient. Such operating parameters define, for example, pacing pulse amplitude, pulse duration, electrode polarity, rate, sensitivity, automatic features, arrhythmia detection criteria, and the amplitude, wave shape and vector of each shocking pulse to be delivered to the patient's heart within each respective tier of therapy.

The operating parameters of the IMD 100 may be non-invasively programmed into the memory 260 through a telemetry circuit 264 in telemetric communication via communication link 266 with the external device 254. The telemetry circuit 264 allows RT data (e.g., intracardiac electrograms) and NRT data (e.g., status information relating to the operation of the IMD 100 as contained in the controller 220 or memory 260) to be sent to the external device 254 through the established communication link 266, such as an SBE link. The telemetry circuit 264 includes a transmitter/receiver (Tx/Rx) 265 and a transmit buffer 267. The Tx/Rx 265 communicates with an external device 254. The controller 220 receives and collects, as inputs from the DAS 252, RT data. The controller 220 is also configured to obtain NRT data. The controller 220 and/or telemetry circuit 264 segments the RT data into RT packets and the NRT data into NRT packets and load the RT and NRT packets into the shared transmit buffer 267 in accordance with RT and NRT bandwidth allocations and/or packet size.

The Tx/Rx 265 is configured to transmit the RT and NRT packets from the IMD to the ExD in an order loaded in the transmit buffer 267. The controller 220 or telemetry circuit 264 is configured to adjust at least one of the RT and NRT bandwidth allocations and/or packet size based on the QoS characteristic. As explained above, the QoS characteristic represents at least one of i) a link quality between the IMD and the ExD, ii) a data rate for RT packets, and iii) a usage level for the transmit buffer.

The controller 220 temporarily pauses the loading of NRT packets to the transmit buffer while the link quality drops below a predetermined link threshold or for a hysteresis time period. The controller 220 temporarily pauses the loading of NRT packets to the transmit buffer while the data rate associated with transmission of RT packets drops below a predetermined RT rate threshold or for a hysteresis time period. The controller 220 temporarily pauses the loading of NRT packets to the transmit buffer while the transmit buffer fills above a predetermined buffer-overflow threshold or for a hysteresis time period. The controller 220 adjusts the bandwidth allocation based on link quality which corresponds to one of a bit error rate, a signal-to-noise ratio, latency, jitter and a number of packet transmit retries out of a predetermined number of packets.

The Tx/Rx 265 includes a receiver configured to receive, from the ExD 254, an instruction directing the IMD 100 to adjust the at least one of the RT and NRT bandwidth allocation.

Optionally, the controller 220 may automatically determine an amount to adjust the at least one of the RT and NRT bandwidth allocation. The controller 220 is configured to: reduce an NRT rate at which NRT packets are loaded to the transmit buffer, relative to an RT rate at which RT packets are loaded when at least one i) of a link quality between the IMD and the ExD, ii) a data rate for RT packets, and iii) a usage level for the transmit buffer reach a corresponding predetermined threshold, and increase the NRT rate relative to the RT rate when a hysteresis timer times out.

As explained above, the RT and NRT data are loaded in an interleaved order into the transmit buffer 267, evenly or unevenly, or with the NRT data being suspended for various periods of time.

The IMD 100 can further include magnet detection circuitry (not shown), coupled to the controller 220, to detect when a magnet is placed over the unit. A magnet may be used by a clinician to perform various test functions of the unit 100 and/or to signal the controller 220 that the external programmer 254 is in place to receive or transmit data to the controller 220 through the telemetry circuits 264.

The IMD 100 can further include one or more physiologic sensors 270. Such sensors are commonly referred to as “rate-responsive” sensors because they are typically used to adjust pacing stimulation rates according to the exercise state of the patient. However, the physiological sensor 270 may further be used to detect changes in cardiac output, changes in the physiological condition of the heart, or diurnal changes in activity (e.g., detecting sleep and wake states). Signals generated by the physiological sensors 270 are passed to the controller 220 for analysis. The controller 220 responds by adjusting the various pacing parameters (such as rate, AV Delay, V-V Delay, etc.) at which the atrial and ventricular pacing pulses are administered. While shown as being included within the unit 100, the physiologic sensor(s) 270 may be external to the unit 100, yet still be implanted within or carried by the patient. Examples of physiologic sensors might include sensors that, for example, sense respiration rate, pH of blood, ventricular gradient, activity, position/posture, minute ventilation (MV), and so forth.

A battery 276 provides operating power to all of the components in the IMD 100. The battery 276 is capable of operating at low current drains for long periods of time, and is capable of providing high-current pulses (for capacitor charging) when the patient requires a shock pulse (e.g., in excess of 2 A, at voltages above 2 V, for periods of 10 seconds or more). The battery 276 also desirably has a predictable discharge characteristic so that elective replacement time can be detected. As one example, the unit 100 employs lithium/silver vanadium oxide batteries.

The IMD 100 further includes an impedance measuring circuit 278, which can be used for many things, including: lead impedance surveillance during the acute and chronic phases for proper lead positioning or dislodgement, detecting operable electrodes and automatically switching to an operable pair if dislodgement occurs, measuring respiration or minute ventilation, measuring thoracic impedance for determining shock thresholds, detecting when the device has been implanted, measuring stroke volume, and detecting the opening of heart valves, and so forth. The impedance measuring circuit 278 is coupled to the switch 226 so that any desired electrode may be used.

The IMD 100 can be operated as an implantable cardioverter/defibrillator (ICD) device, which detects the occurrence of an arrhythmia and automatically applies an appropriate electrical shock therapy to the heart aimed at terminating the detected arrhythmia. To this end, the controller 220 further controls a shocking circuit 282. The shocking circuit 282 generates shocking pulses of low (e.g., up to 0.5 joules), moderate (e.g., 0.5-10 joules), or high energy (e.g., 711 to 40 joules), as controlled by the controller 220. Such shocking pulses are applied to the patient's heart through shocking electrodes. It is noted that the shock therapy circuitry is optional and may not be implemented in the IMD, as the various slave pacing units described below will typically not be configured to deliver high voltage shock pulses. On the other hand, it should be recognized that the slave pacing unit can be used within a system that includes backup shock capabilities, and hence such shock therapy circuitry may be included in the IMD.

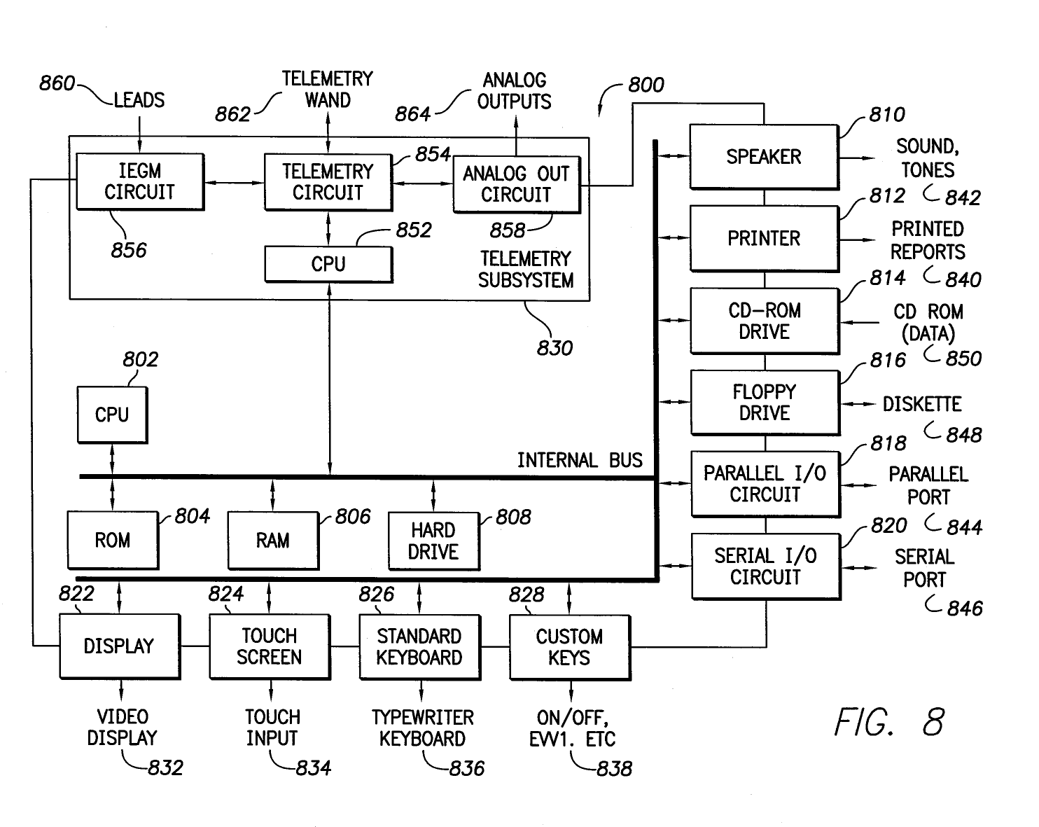

FIG. 8 illustrates a functional block diagram of the external device 800 that is operated in accordance with the processes described herein and to interface with implantable medical devices as described herein. The external device 800 may be a workstation, a portable computer, an IMD programmer, a PDA, a cell phone and the like. The external device 800 includes an internal bus that connects/interfaces with a Central Processing Unit (CPU) 802, ROM 804, RAM 806, a hard drive 808, the speaker 810, a printer 812, a CD-ROM drive 814, a floppy drive 816, a parallel I/O circuit 818, a serial I/O circuit 820, the display 822, a touch screen 824, a standard keyboard connection 826, custom keys 828, and a telemetry subsystem 830. The internal bus is an address/data bus that transfers information between the various components described herein. The hard drive 808 may store operational programs as well as data, such as waveform templates and detection thresholds. The parallel and/or serial IO circuits 818 and 820 receive external data, such as ECG signals, heart sounds, pressure readings, impedance measurements and the like. The CPU 802 processes the external data as described herein for display or otherwise.

The CPU 802 typically includes a microprocessor, a micro-controller, or equivalent control circuitry, designed specifically to control interfacing with the external device 800 and with the IMD 100. The CPU 802 performs the COI measurement process discussed above. The CPU 802 may include RAM or ROM memory, logic and timing circuitry, state machine circuitry, and I/O circuitry to interface with the IMD 100. The display 822 (e.g., may be connected to the video display 832). The touch screen 824 may display graphic information relating to the IMD 100. The display 822 displays various information related to the processes described herein. The touch screen 824 accepts a user's touch input 834 when selections are made. The keyboard 826 (e.g., a typewriter keyboard 836) allows the user to enter data to the displayed fields, as well as interface with the telemetry subsystem 830. Furthermore, custom keys 828 turn on/off 838 the external device 800. The printer 812 prints copies of reports 840 for a physician to review or to be placed in a patient file, and speaker 810 provides an audible warning (e.g., sounds and tones 842) to the user. The parallel I/O circuit 818 interfaces with a parallel port 844. The serial I/O circuit 820 interfaces with a serial port 846. The floppy drive 816 accepts diskettes 848. Optionally, the floppy drive 816 may include a USB port or other interface capable of communicating with a USB device such as a memory stick. The CD-ROM drive 814 accepts CD ROMs 850.

The telemetry subsystem 830 includes a central processing unit (CPU) 852 in electrical communication with a telemetry circuit 854, which communicates with both an IEGM circuit 856 and an analog out circuit 858. The circuit 856 may be connected to leads 860. The circuit 856 is also connected to the implantable leads 114, 116 and 118 to receive and process RT data such as IEGM cardiac signals as discussed above. Optionally, the IEGM cardiac signals sensed by the leads 114, 116 and 118 may be collected by the IMD 100 and then transmitted as RT data, to the external device 800, wirelessly through the telemetry subsystem 830 input.

The telemetry circuit 854 is connected to a telemetry wand 862. The analog out circuit 858 includes communication circuits to communicate with analog outputs 864. The external device 800 may wirelessly communicate with the IMD 100 and utilize protocols, such as Bluetooth, GSM, infrared wireless LANs, HIPERLAN, 3G, satellite, as well as circuit and packet data protocols, and the like. Alternatively, a hard-wired connection may be used to connect the external device 800 to the IMD 100.

FIG. 9 illustrates a distributed processing system 900 in accordance with one embodiment. The distributed processing system 900 includes a server 902 connected to a database 904, a programmer 906, a local RF transceiver 908 (e.g., a Merlin device) and a user workstation 910 electrically connected to a communication system 912. Any of the processor-based components in FIG. 9 (e.g., workstation 910, cell phone 914, PDA 916, server 902, programmer 906, IMD 100) may perform the COI measurement process discussed above.

The communication system 912 may be the Internet, a voice over IP (VoIP) gateway, a local plain old telephone service (POTS) such as a public switched telephone network (PSTN), a cellular phone based network, and the like. Alternatively, the communication system 912 may be a local area network (LAN), a campus area network (CAN), a metropolitan area network (MAN), or a wide area network (WAM). The communication system 912 serves to provide a network that facilitates the transfer/receipt of information such as RT data, NRT data, cardiac signal waveforms, ventricular and atrial heart rates.

The server 902 is a computer system that provides services to other computing systems over a computer network. The server 902 controls the communication of information such as cardiac signal waveforms, ventricular and atrial heart rates, and detection thresholds. The server 902 interfaces with the communication system 912 to transfer information between the programmer 906, the local RF transceiver 908, the user workstation 910 as well as a cell phone 914 and a personal data assistant (PDA) 916 to the database 904 for storage/retrieval of records of information. On the other hand, the server 902 may upload raw cardiac signals, RT and NRT data from an implanted lead 922, surface ECG unit 922 or the IMD 100 via the local RF transceiver 908 or the programmer 906.

The database 904 stores information such as cardiac signal waveforms, ventricular and atrial heart rates, detection thresholds 246 (shown in FIG. 2), and the like, for a single or multiple patients. The information is downloaded into the database 904 via the server 902 or, alternatively, the information is uploaded to the server from the database 904. The programmer 906 is similar to the external device 254 and may reside in a patient's home, a hospital, or a physician's office. The programmer 906 interfaces with the lead 922 and the IMD 100. The programmer 906 may wirelessly communicate with the IMD 100 as explained above to collect and display RT and NRT data and utilize protocols, such as Bluetooth, GSM, infrared wireless LANs, HIPERLAN, 3G, satellite, as well as circuit and packet data protocols, and the like. Alternatively, a hard-wired connection may be used to connect the programmer 906 to the IMD 100. The programmer 906 is able to acquire cardiac signals from the surface of a person (e.g., ECGs), intra-cardiac electrogram (e.g., IEGM) signals from the IMD 100, and/or cardiac signal waveforms, ventricular and atrial heart rates, and detection thresholds from the IMD 100. The programmer 906 displays the ECG and IEGM signals together. The programmer 906 interfaces with the communication system 912, either via the internet or via POTS, to upload the information acquired from the surface ECG unit 920, the lead 922 or the IMD 100 to the server 902.

The local RF transceiver 908 interfaces with the communication system 912 to upload one or more of cardiac signal waveforms, ventricular and atrial heart rates, and detection thresholds 246 (shown in FIG. 2) to the server 902. In one embodiment, the surface ECG unit 920 and the IMD 100 have a bi-directional connection 924 with the local RF transceiver 908 via a wireless connection. The local RF transceiver 908 is able to acquire cardiac signals from the surface of a person, intra-cardiac electrogram signals from the IMD 100, and/or cardiac signal waveforms, ventricular and atrial heart rates, and detection thresholds 246 from the IMD 100. On the other hand, the local RF transceiver 908 may download stored cardiac signal waveforms, ventricular and atrial heart rates, and detection thresholds 246, and the like, from the database 904 to the surface ECG unit 920 or the IMD 100.

The user workstation 910 may interface with the communication system 912 via the internet or POTS to download cardiac signal waveforms, ventricular and atrial heart rates, and detection thresholds via the server 902 from the database 904. Alternatively, the user workstation 910 may download RT and NRT data from the surface ECG units 920, lead 922 or IMD 900 via either the programmer 906 or the local RF transceiver 908. Once the user workstation 910 has downloaded the cardiac signal waveforms, ventricular and atrial heart rates, or detection thresholds, the user workstation 910 may process the information in accordance with one or more of the operations described above. The user workstation 910 may download the information and notifications to the cell phone 914, the PDA 916, the local RF transceiver 908, the programmer 906, or to the server 902 to be stored on the database 904. For example, the user workstation 910 may communicate data to the cell phone 914 or PDA 916 via a wireless communication link 926. The PDA 916 and/or cell phone 914 may receive the RT, NRT and external data from the IMD 100 and surface ECG unit 920 through the internet 912 or a Wi-Fi WAN or Wi-Fi LAN for display.

In accordance with embodiments described herein, methods and systems are provided that limit the real-time data latency and jitter as long as the underlying wireless link capacity supports, and thus improves the real-time data streaming robustness. In accordance with embodiments described herein, methods and systems are provided that maintain high link bandwidth utilization without scarifying the real-time data performance, and thus minimizes the energy consumption for a given amount of data transmitted. In accordance with embodiments described herein, methods and systems are provided that are adaptive to the rapid and unpredictable wireless link quality changes over time.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. While the dimensions, types of materials and coatings described herein are intended to define the parameters of the invention, they are by no means limiting and are exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S.C. §112, sixth paragraph, unless and until such claim limitations expressly use the phrase “means for” followed by a statement of function void of further structure.

What is claimed is:

1. A method in a medical telemetry system for communication between an implantable medical device (IMD) and an external device (ExD), said method comprising:
collecting real-time (RT) data and non-real-time (NRT) data;
segmenting the RT data into RT packets and the NRT data into NRT packets;
loading the RT and NRT packets into a shared transmit buffer in the IMD in accordance with RT and NRT bandwidth allocations;
transmitting the RT and NRT packets from the IMD to the ExD in an order loaded in the transmit buffer; and
adjusting at least one of the bandwidth allocation and packet size based on a quality of service (QoS) characteristic.

2. The method of claim 1, wherein the QoS characteristic represents at least one i) of a link quality between the IMD and the ExD, ii) a data rate for RT packets, and iii) a usage level for the transmit buffer.

3. The method of claim 2, wherein the adjusting operation includes temporarily pausing the loading of NRT packets to the transmit buffer while the link quality drops below a predetermined link threshold or for a hysteresis time period.

4. The method of claim 2, wherein the adjusting operation includes temporarily pausing the loading of NRT packets to the transmit buffer while the data rate associated with transmission of RT packets drops below a predetermined RT rate threshold or for a hysteresis time period.

5. The method of claim 2, wherein the adjusting operation includes temporarily pausing the loading of NRT packets to the transmit buffer while the transmit buffer fills above a predetermined buffer-overflow threshold or for a hysteresis time period.

6. The method of claim 2, wherein the link quality corresponds to one of a signal-to-noise ratio, a bit error rate, latency, jitter and a number of packet transmit retries out of a predetermined number of packets.

7. The method of claim 1, further comprising transmitting, from the ExD, an instruction directing the IMD to dynamically adjust the at least one of the bandwidth allocation and packet size.

8. The method of claim 1, further comprising automatically determining, at the IMD, how to dynamically adjust the at least one of the bandwidth allocation and packet size.

9. The method of claim 1, wherein the adjusting operation comprises:
reducing the bandwidth allocation for NRT packets by reducing an NRT rate at which the NRT packets are loaded to the transmit buffer relative to an RT rate at which the RT packets are loaded, when at least one i) of a link quality between the IMD and the ExD, ii) a data rate for RT packets, and iii) a usage level for the transmit buffer reach a corresponding predetermined threshold; and
increasing the NRT rate relative to the RT rate when a hysteresis timer times out.

10. The method of claim 1, wherein the RT data includes IEGM data collected real-time by the IMD.

11. The method of claim 1, further comprising co-displaying the RT data and ECG signals on a display for the ExD.

12. The method of claim 1, wherein the transmitting operation utilizes a shared best efforts link to convey RT and NRT data to the ExD.

13. An implantable medical device (IMD), comprising:
a transmitter/receiver for communication with an external device (ExD);
inputs configured to collect real-time (RT) data;
a controller configured to obtain non-real-time (NRT) data;
the controller configured to segment the RT data into RT packets and the NRT data into NRT packets and load the RT and NRT packets into a shared transmit buffer in accordance with bandwidth allocation and packet size;
a transmitter configured to transmit the RT and NRT packets from the IMD to the ExD in an order loaded in the transmit buffer; and
wherein the controller is configured to adjust at least one of the bandwidth allocation and packet size based on a quality of service (QoS) characteristic.

14. The IMD of claim 13, wherein the QoS characteristic represents at least one of i) a link quality between the IMD and the ExD, ii) a data rate for RT packets, and iii) a usage level for the transmit buffer.

15. The IMD of claim 14, wherein the controller temporarily pauses the loading of NRT packets to the transmit buffer while the link quality drops below a predetermined link threshold or for a hysteresis time period.

16. The IMD of claim 14, wherein the controller temporarily pauses the loading of NRT packets to the transmit buffer while the data rate associated with transmission of RT packets drops below a predetermined RT rate threshold or for a hysteresis time period.

17. The IMD of claim 14, wherein the controller temporarily pauses the loading of NRT packets to the transmit buffer while the transmit buffer fills above a predetermined buffer-overflow threshold or for a hysteresis time period.

18. The IMD of claim 14, wherein the controller dynamically adjusts the bandwidth allocation or packet size based on link quality which corresponds to one of a signal-to-noise ratio, a bit error rate, latency, jitter and a number of packet transmit retries out of a predetermined number of packets.

19. The IMD of claim 13, further comprising a receiver configured to receive, from the ExD, an instruction directing the IMD to adjust the at least one of the bandwidth allocation and packet size.

20. The IMD of claim 13, wherein the controller automatically determines an amount to adjust the at least one of the bandwidth allocation and packet size.

21. The IMD of claim 13, wherein the controller is configured to:
reduce the bandwidth allocation for the NRT packets by reducing an NRT rate at which NRT packets are loaded to the transmit buffer, relative to an RT rate at which RT packets are loaded when at least one i) of a link quality between the IMD and the ExD, ii) a data rate for RT packets, and iii) a usage level for the transmit buffer reach a corresponding predetermined threshold; and
increase the NRT rate relative to the RT rate when a hysteresis timer times out.
